(19) United States
(12) Patent Application Publication
(10) Pub. No.: US 2007/0131519 A1
(43) Pub. Date: Jun. 14, 2007

(54) DEVICE FOR FEEDING CORKS TO AN AUTOMATIC CORKING MACHINE

(76) Inventor: SERGIO CIRIO, Canelli (Asti) (IT)

Correspondence Address: William B. Patterson;PATTERSON & SHERIDAN, L.L.P., Suite 1500, 3040 Post Oak Blvd., Houston, TX, 77056, US

(21) Appl. No.: 11/459,888

(22) Filed: Jul. 25, 2006

(30) Foreign Application Priority Data
Dec. 12, 2005 (IT) TO2005A000864

(51) Int. Cl. B65G 47/26

(52) U.S. Cl. 198/480.1; 198/459.1; 198/481.1

(57) ABSTRACT

Device for feeding corks to an automatic corking machine comprising a cork transfer wheel rotating around a vertical axis and provided with a plurality of seats distanced one from another in the circumferential direction, the transfer wheel being capable of receiving in said seats successive corks arriving from a stationary loading station. Each of the seats of the transfer wheel has a cork reception zone and a cork release zone distanced one from the other in the radial direction.

### CROSS-REFERENCE TO RELATED APPLICATIONS

This application claims benefit of Italian patent application serial number T02005A000864, filed Dec. 12, 2005, which is herein incorporated by reference.

### BACKGROUND OF THE INVENTION

1. Field of the Invention

The present invention relates in general to the field of equipment for sealing bottles or similar containers by applying corks.

More precisely, the invention concerns a device for feeding corks to an automatic corking machine.

2. Description of the Related Art

Traditionally, corking machines for the insertion of corks of natural cork or synthetic material into the necks of bottles comprise a plurality of clamping devices borne on a turntable, which rotates around a vertical axis, that advances in synchronism with the bottles to be corked. The clamping devices radially compress the corks to be inserted into the bottles, each clamping device being associated to a respective bottle in such a fashion as to remain stationary above the bottle as this advances.

Typically, the corks of natural cork or synthetic material are transferred from a plurality of pipes integral with the turntable and out of alignment with regard to the clamping device, towards the clamping device itself, through a plurality of levers having their fulcrums on the rotating turntable and controlled by a cam wheel.

In more recent machines, the corks of natural cork or synthetic material are brought to the turntable bearing the clamping devices by means of a feeding device that takes up the stoppers at the outlet of a stationary feeding pipe and transfers them in a rhythmic and sequential fashion to the clamping devices.

On each machine there may be present more than one device depending on the capacity of the transporting pipes.

One of the limitations on the performance of the current corking machines consists in the maximum speed of the device for feeding corks. In traditional solutions, indeed, the maximum speed with which the corks can be taken up at the outlet of the transport pipe and transferred to the turntable bearing the clamping devices is limited.

### SUMMARY OF THE INVENTION

The present invention aims to provide an improved device for feeding corks that makes it possible to increase the performance of the corking machine in terms of the machine's maximum production.

According to the present invention, this goal is achieved by a device for feeding corks having the characteristics that are the subject of claim 1.

### BRIEF DESCRIPTION OF THE DRAWINGS

The present invention will now be described in detail with reference to the attached drawings, provided as a simple example and without limiting intent, in which:

FIG. 1 is a partial plan view of a device for feeding corks according to the present invention, and

FIGS. 2, 3 and 4 are sections, respectively along the lines II-II, III-III, and IV-IV of FIG. 1.

### DETAILED DESCRIPTION

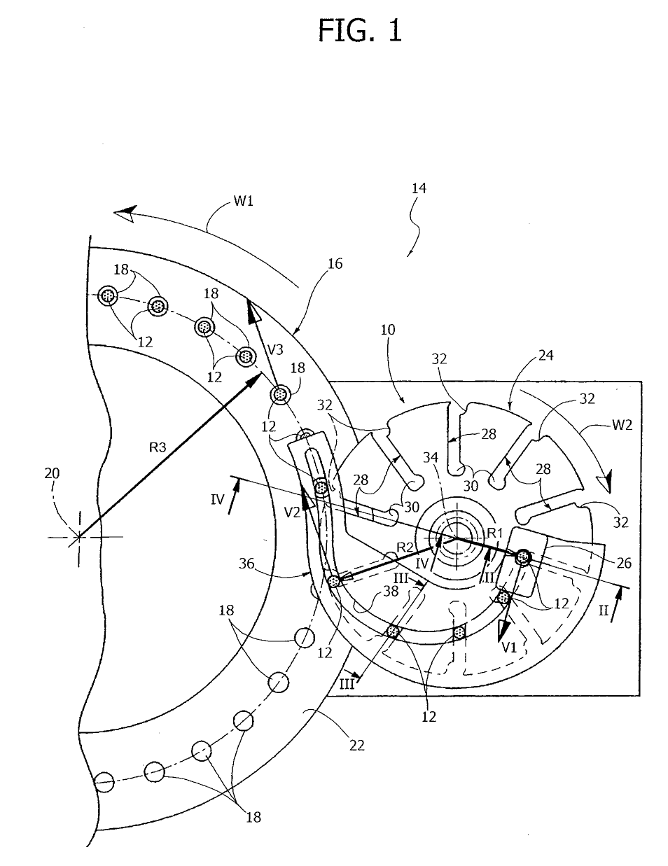

In FIG. 1, a device for feeding corks 12 to an automatic corking machine 14 is indicated with 10.

The corking machine 14 is a machine in general of known type, for example of the type described and illustrated in European Patent No. 1314683 held by the present Applicant. The automatic corking machine 14 is a turntable-type machine, that rotates around a vertical axis and comprises a compression wheel 16 bearing a plurality of clamping devices (not shown) arranged in correspondence with respective housings 18 in the wheel 16, distanced angularly one from another in the circumferential direction.

The clamping devices of the compression wheel 16 are described in detail in the document EP 1314683, quoted above, and are capable of compressing the corks 12 in a radial direction to enable their insertion into the necks of the bottles.

In operation, the compression wheel 16 revolves around the vertical axis 20 with a constant angular speed, indicated in FIG. 1 with W1.

With reference to figures from 1 to 4, the compression wheel 16 has a flat horizontal upper surface 22 in which housings 18 are formed that comprise holes with vertical axis with diameter greater than the diameter of the corks 12. The clamping devices, of known type, that produce the radial compression of the corks 12, are situated below the housings 18.

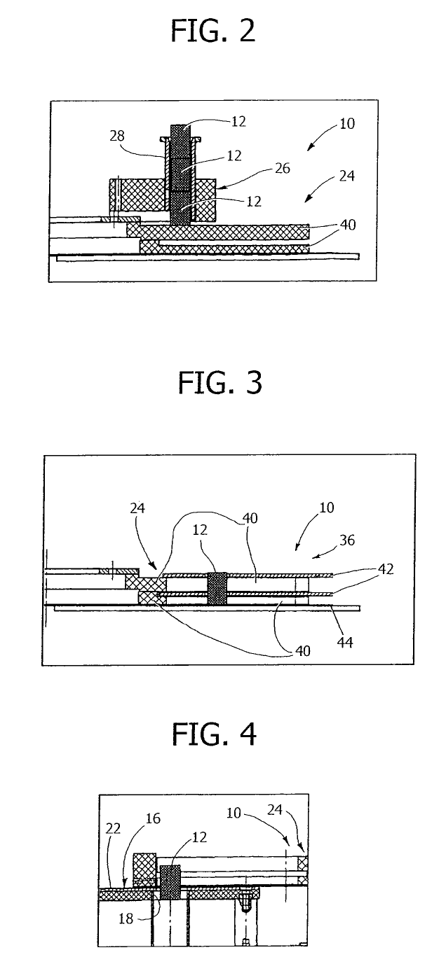

With reference to FIG. 1, the feeding device 10 comprises a transfer wheel 24 whose purpose it is to feed the corks 12 to the compression wheel 16 in angularly distanced positions one from another. The feeding device 10 receives the corks 12 coming from a stationary loading station 26. With reference to FIG. 2, the loading station 26 is connected to a feeding pipe 28 down which the corks 12 advance in a direction parallel to their longitudinal axes maintaining contact one to the next. The passage of the corks 12 from the feeding pipe 28 to the transfer wheel 24 comes about by gravity and may be accelerated by means of an aspirator (not shown).

As they come out of the loading station 26 the corks 12 are taken up individually by the transfer wheel 24 and fed to the compression wheel 16 in a fashion that will be described below.

The transfer wheel 24 takes up the corks 12 as they come out of the stationary loading station 26. The corks leaving the station 26 have zero velocity in the horizontal transfer plane of FIG. 1 and must be accelerated until they reach the peripheral velocity of the compression wheel 16, or a velocity close to the peripheral velocity of the compression wheel 16.

The transfer wheel 24 has a plurality of seats 28 each of which has a cork reception zone 30 and a cork release zone 32, distanced one from the other in a radial direction.

The transfer wheel 24 rotates around a vertical axis 34 parallel to the axis of rotation 20 of the compression wheel 16. The angular velocity of the transfer wheel 24 is indicated with W2 in FIG. 1. The seats 28 of the transfer wheel 24 have a shape such as to guide the corks 12 in an orthogonal direction with regard to the longitudinal axes of the corks. In the example illustrated in the figures, the seats 28 of the transfer wheel 24 are formed of two parallel walls oriented in the radial direction, or inclined with respect to this, and are connected to widened zones that define the cork reception zone 30 and the cork release zone 32.

In the feeding device 10 the corks 12 transported by the transfer wheel 24 rest on a plate 44 that may be stationary or rotating.

The feeding device 10 also includes a stationary guide 36 that guides the movement of the corks 12 from the stationary loading station 26 to the position in which the corks 12 are taken up by the compression wheel 16. From the construction standpoint, the guide 36 is formed of a plate in which a curved slot 38 is practised inside of which the corks 12 slide. Each cork 12 as it progresses from the stationary loading station 26 to the compression wheel 16 occupies at the same time a housing 28 of the transfer wheel 24 and the curved slot 38. The slot 38 guides the movement of the corks within their respective seats 28 between the reception zone 30 and the release zone 32 of each housing 28.

With reference to FIG. 3, the transfer wheel 24 preferably comprises two discs 40 bearing the housings 28, superimposed one above the other and distanced one from another in the axial direction. The guide 36 is preferably situated between the two discs 14 of the transfer wheel 24.

A possible variant consists in the transfer wheel 24 being made with a number of discs 40 other than two; another possible variant consists in the guide 36 being made with more than one single plate 42.

With reference to FIG. 1, the corks arriving from the stationary loading station 26 are taken up by the transfer wheel 24. Each cork 12 enters the reception zone 30 of its respective seat 28.

When the cork 12 is taken up by the transfer wheel 24, its velocity on the transfer plane is equal to: V1=R1×W2, where R1 is the distance of the cork reception zone 30 from the axis of rotation 34.

The transfer wheel 24 rotates with a constant angular speed. The corks 12, by effect of the rotation of the transfer wheel 12, move contemporaneously along the curved slot 38 and along the seats 28. By effect of this movement, the corks 12 progresses from a radially inner zone to a radially outer zone of the transfer wheel 24. In consequence, while the angular velocity W2 of the transfer wheel 24 remains constant, the peripheral velocity of the corks 12 in the transfer plane progressively increases until it reaches V2=R2×W2, where R2 is the distance of the cork release zone 32 from the rotation axis 24. The velocity V2 is equal to or slightly inferior to the peripheral velocity V3 of the seats 18 equal to: V3=R3×W1, where R3 is the distance of the cork reception zone 18 from the rotation axis 20.

The corks 12, when they reach the outer extremity of the transfer wheel 24, engage a free housing 18 of the compression wheel 16 and are taken up by this wheel at a velocity V3.

The passage of the corks 12 from the cork release zone 32 to the cork reception housing 18 comes about by gravity and may be accelerated by means of an aspirator (not shown).

The velocity V1 at which the corks are taken from the stationary loading station 26 is markedly lower than the velocity V3 at which the corks are transferred to the compression wheel 16. This greatly facilitates the passage of the corks 12 from the stationary loading station 26 to the transfer wheel 24.

Thanks to this characteristic it is possible to considerably increased the performance of the automatic corking machine 14. In terms of the machine's maximum production, it is possible to increase the performance by approximately 30% compared to traditional solutions.

Naturally, while the principle of the invention holds good, the details of construction and the embodiments may vary widely with regard to what is described and illustrated here, without thereby departing from the scope of the present invention as defined in the attached claims.

1. Device for feeding corks to an automatic corking machine, comprising a cork transfer wheel rotating around a vertical axis and provided with a plurality of seats distanced one from another in the circumferential direction, the transfer wheel being capable of receiving in said seats successive corks arriving from a stationary loading station,
each of the housings of the transfer wheel having a cork reception zone and a cork release zone distanced one from the other in a radial direction.

2. Device according to claim 1, wherein the feeding device includes a stationary guide that engages the corks carried by the transfer wheel and arranged in such a way as to guide the corks from the stationary loading station to a position from which the corks can be taken up by a compression wheel being part of an automatic corking machine.

3. Device according to claim 2, wherein the stationary guide is arranged so as to guide the corks engaging said seats of the transfer wheel from the reception zone towards the release zone by effect of the rotation of the transfer wheel.

4. Device according to claim 1, wherein each of said seats of the transfer wheel has a pair of guide walls that communicate at their ends with enlarged portions defining respectively the reception zone and the release zone.

5. Device according to claim 3, wherein the transfer wheel comprises one or more superimposed discs bearing said seats, distanced one from the other in the axial direction and between which said stationary guide is situated.

6. Device according to claim that 3, wherein the stationary guide comprises one or more parallel plates.
